(19) United States
(12) Patent Application Publication
(10) Pub. No.: US 2018/0280806 A1
(43) Pub. Date: Oct. 4, 2018

(54) GAME SERVER

(71) Applicant: KABUSHIKI KAISHA SEGA Games doing business as SEGA Games Co., Ltd., Tokyo (JP)

(72) Inventors: Takahiro Otomo, Tokyo (JP); Kensuke Arai, Tokyo (JP)

(73) Assignee: KABUSHIKI KAISHA SEGA Games doing business as SEGA Games Co., Ltd., Tokyo (JP)

(21) Appl. No.: 15/941,865

(22) Filed: Mar. 30, 2018

(30) Foreign Application Priority Data
Mar. 31, 2017 (JP) 2017-069784

(51) Int. Cl. A63F 13/795; A63F 13/35; A63F 13/71; A63F 13/77

(52) U.S. Cl. CPC A63F 13/795; A63F 13/77; A63F 13/71; A63F 13/35

(57) ABSTRACT

A game server connected to a plurality of game terminals via a communication network is disclosed including a receiver that receives a first request to register an invitation code for a game that is available for download, from a first game terminal operated by a first player, a memory, a processor connected to the memory and that causes the memory to register the invitation code in a state that allows acquisition from another game terminal, and a transmitter. The receiver receives a second request to acquire the invitation code from a second game terminal operated by a second player. The transmitter transmits the invitation code to the second game terminal in response to the reception of the second request. The processor causes the memory to register the invitation code based on the reception of the first request, regardless of whether or not the first player has a game play history.

### TECHNICAL FIELD

The present invention generally relates to a technique for inviting other players to a network game.

### RELATED ART

The use of smartphones as game terminals, and not just as communication terminals, has become quite popular. Network games that are enjoyed on smartphones are provided by using a smartphone to access a platform built into a game server. Network games are usually designed to emphasize character development, cooperation and competition with other players, and the collection of cards and items.

A player can enjoy a network game by himself, or the user can form a game group and enjoy it with a plurality of players. One aspect of a network game is that the player pool is expanded as existing players invite new players.

Patent Literature 1 discloses the use of what is called an invitation code, as a method for having a certain player X1 invite another player Y1 to a game. When the player X1 provides the invitation code to the player Y1, the player Y1 can enjoy various rewards (such as items) in the game by inputting the invitation code to the game server. Rewards are an incentive for the player Y1 to participate in the game. Also, if a reward is granted to the player X1 who invited the player Y1, this boosts the incentive for recruitment.
Patent Literature 1: Japanese Patent No. 5,545,325

However, players who have never played a network game to which they are invited (invitees) may be hesitant to respond to solicitations from players who are familiar with the game (inviting parties). The reason is that since there is obviously a big difference between the inviting party and the invitee when it comes to the degree of proficiency at the network game, the invitee thinks that he will not be able to enjoy playing with the inviting party. In particular, long-selling games that have been out for a long time since their release usually have many advanced players, so there is sometimes a dilemma in that new players shy away from these games.

### SUMMARY

One or more embodiments of present invention provide a technique for encouraging the participation of new players in a network game.

A game server according to one or more embodiments of the present invention is connected to a plurality of game terminals via a communication network. The game server includes a code registration receiver that receives a request to register an invitation code for a game specified by a first player, from a first game terminal operated by the first player, a code registration receiver that receives a request to register an invitation code for a game that is available for download, from a first game terminal operated by the first player, a code request receiver that receives a request to acquire the invitation code from a second game terminal operated by a second player, and a code transmitter that transmits the invitation code to the second game terminal. The code registration component registers the invitation code of the game requested for registration by the first player, regardless of whether or not the first player has a game play history.

One or more embodiments of the present invention provide a game server that is connected to a plurality of game terminals via a communication network. The game server includes a code issue receiver that receives a request to issue an invitation code for the game specified by a first player, from a first game terminal operated by the first player, and a code transmitter that transmits the invitation code to another game terminal. The code issue receiver accepts a request to issue an invitation code from the first player regardless of whether or not the first player has a game play history.

One or more embodiments of the present invention provide a game server that is connected to a plurality of game terminals via a communication network. The game server includes a code registration receiver that receives a request to register an invitation code for a game specified by a first player, from a first game terminal operated by the first player, a code registration component that registers the invitation code in a state that allows acquisition from another game terminal, a code request receiver that receives a request to acquire the invitation code, from a second game terminal operated by a second player and from a third game terminal operated by a third player, a code transmitter that transmits the invitation code to the second game terminal and to the third game terminal, and a registration notification component that notifies the second game terminal of the player registration of the third player, and notifies the third game terminal of the player registration of the second player, on the condition that the second player has been registered as a player in the game after the acquisition of the invitation code of the game, and the third player has also been registered as a player in the game after the acquisition of the invitation code of the game.

One or more embodiments of the present invention provide a game server connected to a plurality of game terminals via a communication network. The game server includes a receiver that receives a first request to register an invitation code for a game that is available for download, from a first game terminal operated by a first player, a memory, a processor connected to the memory and that causes the memory to register the invitation code in a state that allows acquisition from another game terminal, and a transmitter. The receiver receives a second request to acquire the invitation code from a second game terminal operated by a second player. The transmitter transmits the invitation code to the second game terminal in response to the reception of the second request. The processor causes the memory to register the invitation code based on the reception of the first request, regardless of whether or not the first player has a game play history.

One or more embodiments of the present invention provide a game server connected to a plurality of game terminals via a communication network. The game server includes a receiver that receives a request to issue an invitation code for a game specified by a first player, from a first game terminal operated by the first player, and a transmitter that transmits the invitation code to a second game terminal, a processor causes the receiver to receive a request to issue the invitation code from the first player regardless of whether or not the first player has a game play history.

One or more embodiments of the present invention provide a game server connected to a plurality of game terminals via a communication network. The game server includes a receiver that receives a first request to register an invitation code for a game specified by a first player, from a first game terminal operated by the first player, a memory, a processor connected to the memory and that causes the memory to register the invitation code in a state that allows acquisition from another game terminal, and a transmitter. The receiver receives a second request to acquire the invitation code, from a second game terminal operated by a second player and from a third game terminal operated by a third player. The transmitter transmits the invitation code to the second game terminal and to the third game terminal. The transmitter transmits a notification that notifies the second game terminal of the player registration of the third player. In response to the second player being registered as a player in the game after the acquisition of the invitation code of the game and the third player being registered as a player in the game after the acquisition of the invitation code of the game, the terminal transmits a notification that notifies the third game terminal of the player registration of the second player.

According to one or more embodiments of the present invention, it is easier to encourage the participation of new players in a network game.

### BRIEF DESCRIPTION OF DRAWINGS

FIG. 1 is a hardware configuration diagram of a game system according to one or more embodiments of the present invention.

FIG. 2 is a functional block diagram of the game system according to one or more embodiments of the present invention.

FIG. 3 is a data structure diagram of play history information according to one or more embodiments of the present invention.

FIG. 4 is a data structure diagram of matching history information according to one or more embodiments of the present invention.

FIG. 5 is a data structure diagram of granting condition information according to one or more embodiments of the present invention.

FIG. 6 is a data structure diagram of login information according to one or more embodiments of the present invention.

FIG. 7 is a data structure diagram of item information according to one or more embodiments of the present invention.

FIG. 8 is a screen shot of a ranking screen according to one or more embodiments of the present invention.

FIG. 9 is a screen shot of a profile screen according to one or more embodiments of the present invention.

FIG. 10 is a screen shot of an invitation code acquisition screen according to one or more embodiments of the present invention.

FIG. 11 is a flowchart of the process of posting an invitation game according to one or more embodiments of the present invention.

FIG. 12 is a flowchart of the process of issuing an invitation code according to one or more embodiments of the present invention.

FIG. 13 is a flowchart of the process of downloading a game program according to one or more embodiments of the present invention.

FIG. 14 is a flowchart of the process of transmitting an invitation code according to one or more embodiments of the present invention.

FIG. 15 is a flowchart of the process of granting a reward when an invitee has entered an invitation game based on an invitation code according to one or more embodiments of the present invention.

### DETAILED DESCRIPTION

Embodiments of the present invention will be described below through reference to the drawings. However, embodiments of the present invention described below are nothing but an example, and are not intended to exclude the application of various modifications or techniques not specifically expressed below. That is, embodiments of the present invention can be modified in various ways without departing from the gist thereof. Also, in the discussion of the drawings below, portions that are the same or similar will be assigned the same or similar reference signs. The drawings are simplified, and do not necessarily match the actual dimensions, proportions, and so forth. From one drawing to the next, there may be portions in which the dimensional relations and proportions are not the same.

In the early period after a network game is released, most players are lower level players. However, as time passes after the release (that is, after the game has been released for players to download), the number of advanced players begins to rise. One way of enjoying a network game is to form a game group with a number of players, and help other friends within the game group. However, with a network game for which there are many advanced players, a new player can find it hard to create a game group made up mainly of lower level players who are at his own level (hereinafter also referred to as a “lower level group”). As a result, a long-selling network game may end up being a game which only advanced players can fully enjoy, and which new players can find difficult to challenge.

However, even with such a long-selling game, if a lower level group can be put together, then lower level players can play the game at their own pace. In one or more embodiments, a method for encouraging the participation of new players in a network game by encouraging the formation of a lower level group in a game that has already been released for players to download is described.

According to one or more embodiments, a player who is the inviting party provides an invitation code to players who are the invitees, thereby encouraging new players to participate. Just as in the past, the inviting party may send the invitation code addressed to the invitees (hereinafter referred to as “direct invitation method”), or may register the invitation code on his profile page and allow the invitees to acquire it (hereinafter referred to as “indirect invitation method”). The inviting party can provide the other players with the invitation code of the game to be invited (hereinafter referred to as “invitation game”) even if he has no play experience with the invitation game.

In the indirect invitation method, the inviting party posts the invitation code on his profile page, and other players (invitees) access the inviting party's profile page and actively acquire the invitation code from there.

For example, the invitation code for the invitation game G1 (first game) recommended by a player X2 (first player) is posted on the profile page (a web page for self-introduction) of the player X2 in a game G2 (second game). A player Y2 (second player) of the game G2 might also be interested in the game G1 after looking at the profile page of the player X2. The player Y2 can acquire the invitation code for the game G1 from the profile page of the player X2. After acquiring the invitation code for the game G1, if the player Y2 registers as a player (hereinafter also referred to as “enter” or an “entry”) in the game G1, or if the player Y2 actually plays the game G1, the player X2 and the player Y2 are granted rewards.

The following description will focus on the processing steps for encouraging the formation of a lower level group by a player who invites other players, by the direct invitation method and the indirect invitation method.

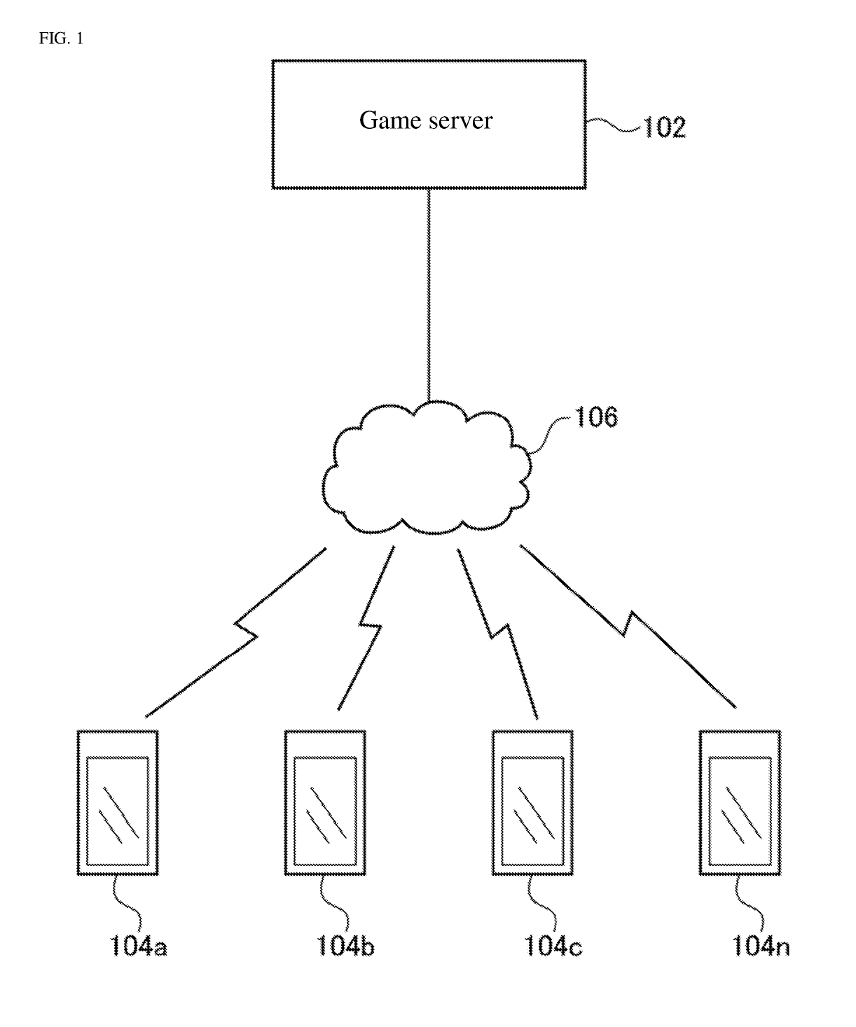

FIG. 1 is a hardware configuration diagram of a game system 100 according to one or more embodiments.

In the game system 100, a plurality of game terminals 104a, 104b, 104c, . . . , 104n (hereinafter, when referred to as a group, or when discussed without being distinguished from one another, these will be collectively called the “game terminals 104”) are connected to a game server 102 via the Internet 106. The game terminals 104 are assumed to be smartphones. The game terminals 104 may be a portable dedicated game machine, or may be a general-purpose computer such as a laptop PC. The game terminals 104 and the Internet 106 are connected wirelessly, but may instead be connected by wire. A unique ID called a player ID is assigned ahead of time to the player of the game. The game server 102 provides the game to each of the game terminals 104.

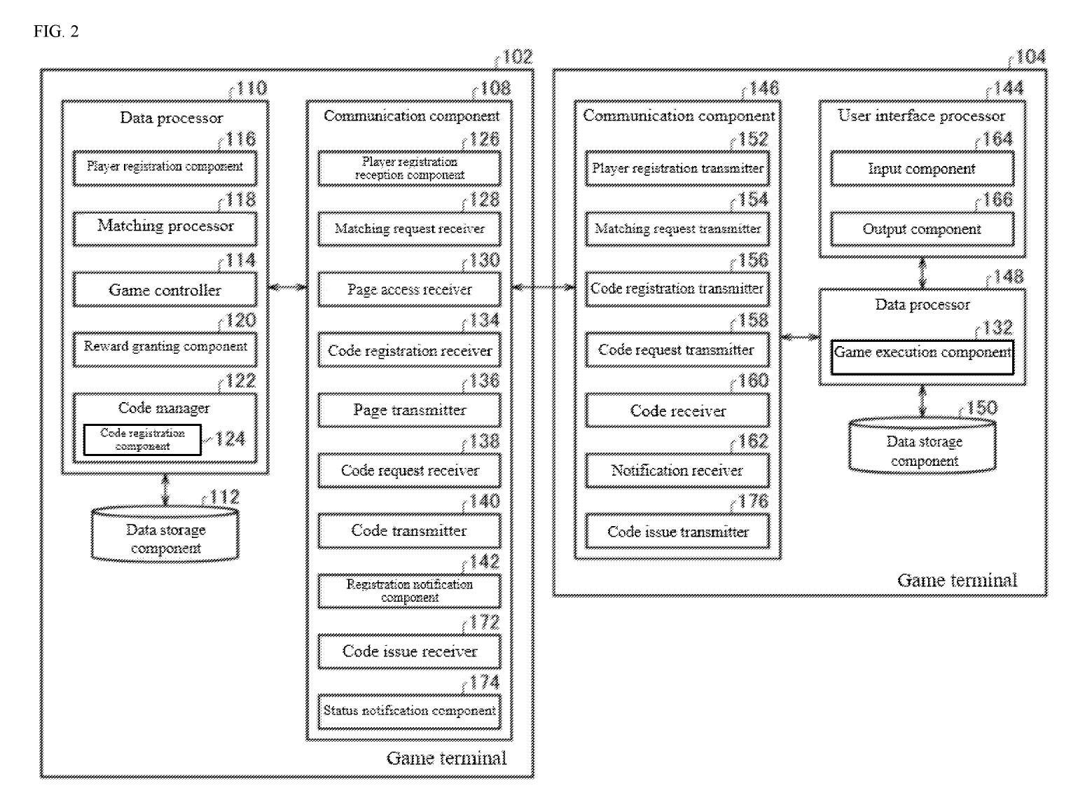

FIG. 2 is a functional block diagram of the game system 100 according to one or more embodiments.

As described above, the game system 100 includes the game server 102 and the game terminals 104. The constituent elements of the game terminals 104 and the game server 102 are made up of hardware such as a CPU (central processing unit), a computing device such as various co-processors, a storage device such as a memory or storage, and a wired or wireless communication line connecting these, and software that is stored in the storage device and supplies processing commands to the computing device. The computer program may be constituted by a device driver, an operating system, various application programs located in upper layers thereof, and a library that provides shared functions to these programs. The blocks described below are not configured in hardware units, but are functional unit blocks.

The game server 102 may have a configuration including a web server, or the game terminal 104 may include a portable communication terminal and a web browser installed in the portable communication terminal.

Game Server 102

The game server 102 includes a communication component 108, a data processor 110, and a data storage component 112.

The communication component 108 handles processing for communication with the game terminals 104 via the Internet 106. The data storage component 112 stores various kinds of data. The data processor 110 executes various kinds of processing based on the data acquired by the communication component 108 and the data stored in the data storage component 112. The data processor 110 also functions as an interface for the communication component 108 and the data storage component 112. The data storage component 112 stores various kinds of data.

In addition to the game program, the data storage component 112 stores information indicating the play status of the players. The play status is information related to the player ranking of a player, the level and equipment of a player character, possessed items, skills, and the like. The invitation code issue history is also stored in the data storage component 112.

The data processor 110 includes a player registration component 116, a matching processor 118, a game controller 114, a reward granting component 120, and a code manager 122.

The player registration component 116 accepts a request for entry to the game (registration request) from the game terminal 104 via the communication component 108. The player registration component 116 assigns a player ID to a player upon entry. An entry request is automatically transmitted when the game program is installed in the game terminal 104.

The matching processor 118 performs matching (linking) between players. When the communication component 108 receives a group creation request from a player Z1, the communication component 108 sets up a game group and makes public the opening of that game group. Next, when a group participation request specifying this game group has been received from a player Z2, the matching processor 118 adds the player Z2 to the game group opened by the player Z1. Players belonging to the same game group can cooperate and enjoy the same game. The matching processor 118 can also set up a battle between a plurality of players. The matching processor 118 registers the relationship between the players as needed in the matching history information (discussed below).

When a player wishes to build and maintain an ongoing relationship with another player, that player can make a friend request. For example, when a player Z3 transmits a friend request to the game server 102 for a player Z4, the matching processor 118 notifies the game terminal 104 of player Z4 that there is a friend request from player Z3. If player Z3 approves this, players Z3 and Z4 become “friends.”

Being a friend has numerous advantages, such as being able to find out details about the play history of friend players, being helped by the characters owned by friend players as non-player characters (NPC) when playing a game alone, and being able to exchange and borrow information and items among friend players. The advantage of being friends can be designed according to the game, but at the very least, “friends” may be a relationship in which two or more players register with each other for the purpose of maintaining an ongoing relationship.

The game controller 114 controls the progress of the game in conjunction with the game execution component 132 of the game terminal 104.

The reward granting component 120 grants rewards to both the inviting party and invitees upon the entry of invitees into the invitation game. This will be described in detail below, but the “reward” referred to here means any beneficial information or things that are useful for the player in order to advance in the game, such as characters or items, game points (currencies that can be used in the game), resources, and so forth.

The code manager 122 manages the issue history of the invitation code. The code manager 122 includes a code registration component 124. Upon receiving a request from the game terminal 104 of the inviting party (first player) (hereinafter referred to as the “invitation terminal (first game terminal)”), the code registration component 124 registers an issue button (acquisition means) for acquiring the invitation code on the profile page of the inviting party. Hereinafter, the game terminal 104 of the invitee (second player) will also be referred to as the “invitee terminal (second game terminal).”

The communication component 108 includes a player registration receiver 126, a matching request receiver 128, a page access receiver 130, a code registration receiver 134, a page transmitter 136, a code request receiver 138, a code transmitter 140, a registration notification component 142, a code issue receiver 172, and a status notification component 174.

The player registration receiver 126 receives an entry request from a game terminal 104. The entry request includes a game ID for identifying the game to be entered (hereinafter also referred to as “GID”) and the player ID of the player making the request. The matching request receiver 128 receives group creation requests and group participation requests. The matching request receiver 128 also receives battle requests and friend requests. Requests for establishing relationships among players, such as group creation requests and friend requests, will hereinafter be referred to collectively as “matching requests.”

The page access receiver 130 receives a request to access the profile page (web page) from the game terminal 104. The code registration receiver 134 receives a request to register an invitation code for the profile page from the invitation terminal. The registration of the invitation code referred to here may involve posting the invitation code (character string) just as it is shown on the profile page, or registering an invitation code acquisition means, such as the issue button discussed below.

The page transmitter 136 transmits the profile page to the game terminal 104. The code request receiver 138 receives a request to acquire an invitation code from the game terminal 104 (the invitee terminal). The code transmitter 140 transmits the invitation code to the invitee terminal. When the invitee enters the game, the registration notification component 142 notifies the invitation terminal to that effect.

The code issue receiver 172 receives the invitation code from the game terminal 104 in the direct invitation method. The status notification component 174 notifies the game terminal 104 of the play status of the inviting party in the invitation game. The “play status” referred to here means the play history of the inviting party in the invitation game.

Game Terminal 104

Each game terminal 104 includes a user interface processor 144, a communication component 146, a data processor 148, and a data storage component 150.

In addition to accepting operations from the player via the touch panel, the user interface processor 144 also handles processing related to the user interface, such as image display and audio output. The communication component 146 handles processing for communication with the game server 102 and other game terminals 104 via the Internet 106. The data storage component 150 stores various kinds of data. The data processor 148 executes various kinds of processing based on the data acquired by the user interface processor 144 and the communication component 146 and the data stored in the data storage component 150. The data processor 148 also functions as an interface for the user interface processor 144, the communication component 146, and the data storage component 150.

The data processor 148 includes a game execution component 132.

The game execution component 132 controls the progress of the game in conjunction with the game server 102. The game execution component 132 of the game terminal 104 may be formed as a software program downloaded from the game server 102 as part of the function of the game controller 114. The game execution component 132 according to one or more embodiments also generates an invitation code.

The communication component 146 includes a player registration transmitter 152, a matching request transmitter 154, a code registration transmitter 156, a code request transmitter 158, a code receiver 160, a notification receiver 162, and a code issue transmitter 176.

The player registration transmitter 152 transmits an entry request. Entry requests are sent automatically when a game is installed. The matching request transmitter 154 transmits a matching request such as a group creation request or a friend request. When the game terminal 104 functions as the invitation terminal, the code registration transmitter 156 transmits a request to register the invitation code on the profile page. An invitation code registration request includes the game ID, the player ID, and the invitation code. When the game terminal 104 functions as an invitee terminal, the code request transmitter 158 transmits a request to acquire an invitation code. The code receiver 160 receives an invitation code when functioning as an invitee terminal. When functioning as an invitation terminal, the notification receiver 162 receives a registration notification indicating that the invitee has entered the invitation game.

The code issue transmitter 176 corresponds to the direct invitation method. The code issue transmitter 176 transmits the invitation code addressed to the player designated by the inviting party. The game server 102 also relays the invitation code in the direct invitation method.

The communication component 146 acquires various kinds of game information from the game server 102, and the data processor 148 causes the user interface processor 144 to display a game screen. Also, the user interface processor 144 detects various kinds of user input, and the data processor 148 notifies the game server 102 of the input information via the communication component 146. The game controller 114 of the game server 102 controls the progress of the game in conjunction with the game execution component 132 of the game terminal 104 in accordance with this input information.

The user interface processor 144 includes an input component 164 for accepting input from the player, and an output component 166 for outputting various kinds of information such as images and sounds to the player. The input component 164 mainly detects a touch operation by the player on the screen as an input.

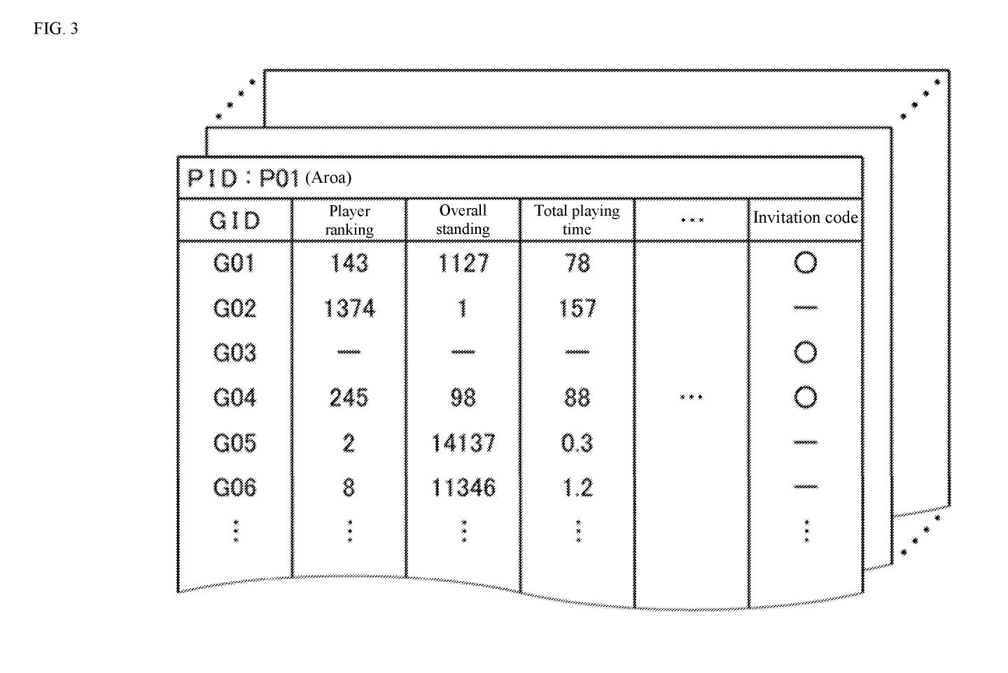

FIG. 3 is a data structure diagram of play history information 170 according to one or more embodiments.

The play history information 170 is stored in the data storage component 112 of the game server 102. The play history information 170 indicates a play history for each player and for each game, and the game controller 114 updates the play history information 170 every time the game is played. FIG. 3 shows the play history of a player with a player ID of P01 (hereinafter referred to as “player (P01)”).

The registered name of the player (P01) is “Aroa.” The player (P01) has played several kinds of games such as the game (G01) and the game (G02). As shown in FIG. 3, the player (P01) has a total of 78 hours of play experience for the game (G01), and a player ranking of 143. The player ranking is an index that refers to the skill level of a player with respect to a game, and is normally increased every time the player completes a mission set up during the game. The overall standing of the player (P01) in the game (G01) is 1127^{th} place. The player (P01) posts an invitation code (hereinafter referred to as “invitation code (G01)”) for the game (G01) (described in detail below).

The player ranking of the player (P01) in the game (G02) is 1374, and his overall standing is 1^{st} place. The player (P01) has not posted the invitation code (G02). The player (P01) has never played the game (G03), but has posted the invitation code (G03). Invitation codes may also be posted in this manner for unplayed games.

In addition to this, the play history also includes stages and missions that have recently been completed, the number of enemies defeated and various other such results, possessed characters, character levels, possessed items, and weapons, armor, and other such possessions.

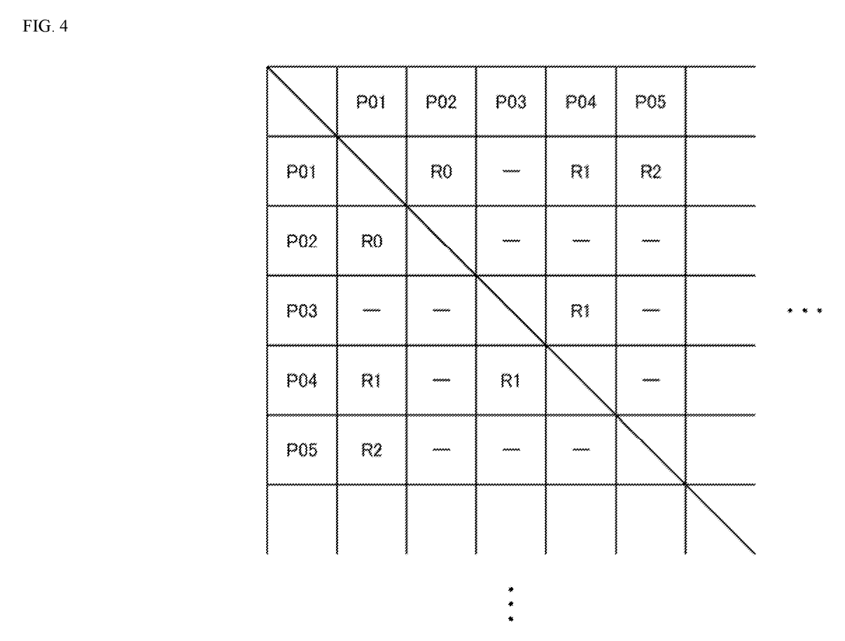

FIG. 4 is a data structure diagram of the matching history information 180 according to one or more embodiments.

The matching history information 180 is stored in the data storage component 112 of the game server 102. The matching history information 180 indicates the matching history for each player, and the matching processor 118 updates the matching history information 180 each time a match is established or eliminated.

In the matching history information 180, the matching relationship between players is indicated by the symbols R0 to R2. R0 indicates a friend relationship. In FIG. 4, the player (P01) and the player (P02) are in a friend relationship.

R1 means that players belong to the same game group in one or more of the games. A game group is formed for the purpose of doing battle with a common enemy or another game group, or for battling and competing within a game group. What is generally referred to as a team or guild also falls under the category of game group as used here. In FIG. 4, the player (P01) and the player (P04) belong to the same game group.

R2 indicates a relationship in which players belonged to the same game group in the past, but now do not belong to the same game group. In FIG. 4, it can be seen that the player (P01) and the player (P05) belonged to the same game group in the past. Also, R2 may include a history of personal exchanges such as having battle experience or having conversed with one another on an SNS (social networking service), despite not belonging to the same game group.

In FIG. 4, there is no matching history for the player (P01) and the player (P03). In other words, they are neither friends nor belong to the same game group.

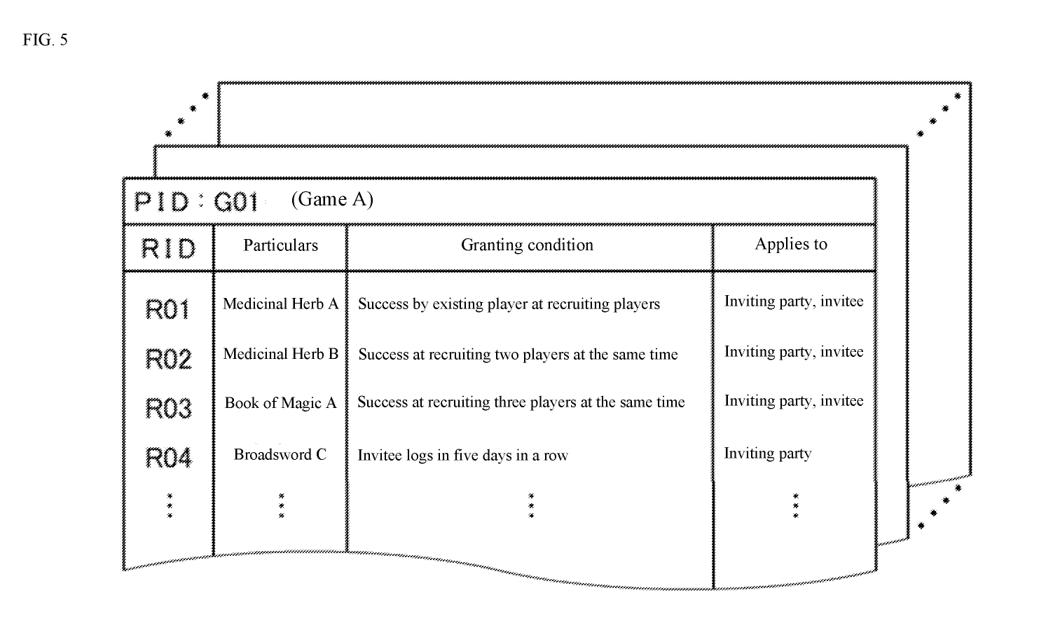

FIG. 5 is a data structure diagram of granting condition information 220 according to one or more embodiments.

The granting condition information 220 is stored in the data storing component 112 of the game server 102. The granting condition information 220 defines conditions for granting rewards to the inviting party and invitees (hereinafter referred to as “granting conditions”). In general, a player who has entered into an invitation game (hereinafter referred to as an “existing player”) becomes an inviting party, and usually recruits unregistered players. According to one or more embodiments, players who are unregistered in the invitation game, and not just existing players, can become an inviting party and recruit other unregistered players. The granting condition information 220 shown in FIG. 5 shows the conditions for the granting of various rewards in the game (G01) (game title “game A”).

The reward with a reward ID (hereinafter also referred to as “RID”) of R01, that is, the content of the reward (R01), is a “medicinal herb A,” which is granted when an existing player (inviting party) has succeeded at recruiting an unregistered player (invitee). The reward granting component 120 grants the reward (R01) to both the inviting party and the invitee when this granting condition is met. “Succeeded at recruiting” means that an invitee has used the invitation code provided by the inviting party and entered into the invitation game. Rather than being limited to entry, “succeeded at recruiting” may also mean that the invitee has installed the invitation game on the game terminal 104, or that the invitee has played the invitation game at least a predetermined number of times or for at least a predetermined length of time.

The “medicinal herb B” of the reward (R02) is granted to both the inviting party and the invitee when two players have been successfully recruited at the same time. The phrase “at the same time” here means that when the players Y3 and Y4 have entered the invitation game upon the recruitment of the player X3, the difference between when the player Y3 entered and when the player X4 entered is within a certain length of time (hereinafter referred to as a “quasi-simultaneous period”). The same applies when there are three or more people. According to one or more embodiments, the quasi-simultaneous period is described as being 24 hours. When a plurality of invitees use an invitation code to enter the invitation game “at the same time,” these invitees will be referred to as being in a “simultaneous participation relationship.” A plurality of players in a simultaneous participation relationship are all new players, so it will be easy for them to form a lower level group. In view of this, as an incentive to simultaneously recruit multiple new players, the reward granting component 120 grants the reward (R02) to the inviting party and to each of the invitees.

A simultaneous participation relationship could also be established between an inviting party and invitees. Let us assume that an unregistered player X5 uses an issued invitation code, and an unregistered player Y5 enters the invitation game. If the player X5 (the inviting party) also enters after the unregistered player Y5 enters and before the end of the quasi-simultaneous period, then a simultaneous participation relationship will be established between the players X5 and Y5. Here again, the reward granting component 120 may grant rewards to both the inviting party X5 and the invitee Y5.

Granting conditions may be set after entry, and not just at the time of entry. A granting condition that is set in relation to the play history after entry is in particular called a “continuation condition.” According to one or more embodiments, a continuation condition is met when an invitee who has entered the invitation game has logged in to (started playing) this invitation game five days in a row, and the reward granting component 120 grants the reward (R04) to the inviting party. In a mode such as this, the inviting party can acquire rewards not only by successfully recruiting other players, but also when those players continue to play the invitation game. If an invitee invests in the invitation game, this will also be advantageous to the inviting party. Furthermore, when a continuation condition is met, the reward granting component 120 may grant a reward only to the invitee, or may grant rewards to both the inviting party and the invitee.

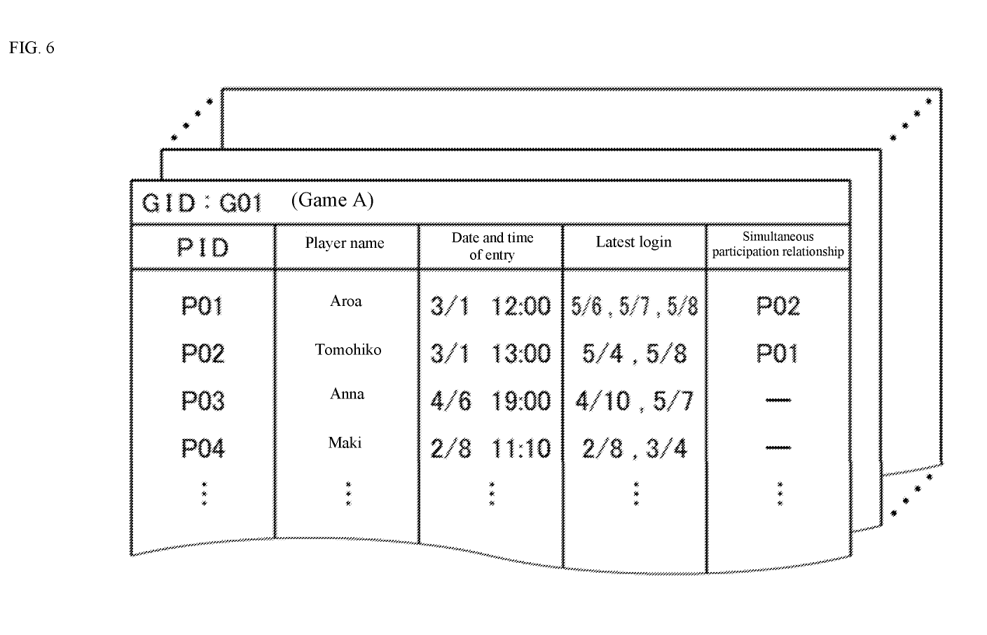

FIG. 6 is a data structure diagram of login information 230 according to one or more embodiments.

The login information 230 is stored in the data storage component 112 of the game server 102. The login information 230 is information indicating the login status of players of the game. The login information 230 in FIG. 6 indicates the login status of the plurality of players in the game (G01) (game title “Game A”).

The player (P01) (player name “Aroa”) entered the game (G01) at noon on March 1. Recently, he has logged in to the game (G01) on three consecutive days: May 6, 7, and 8. The player (P02) (player name “Tomohiko”) entered the game (G01) at 1:00 p.m. on March 1. The player (P01) and the player (P02) are in a simultaneous participation relationship.

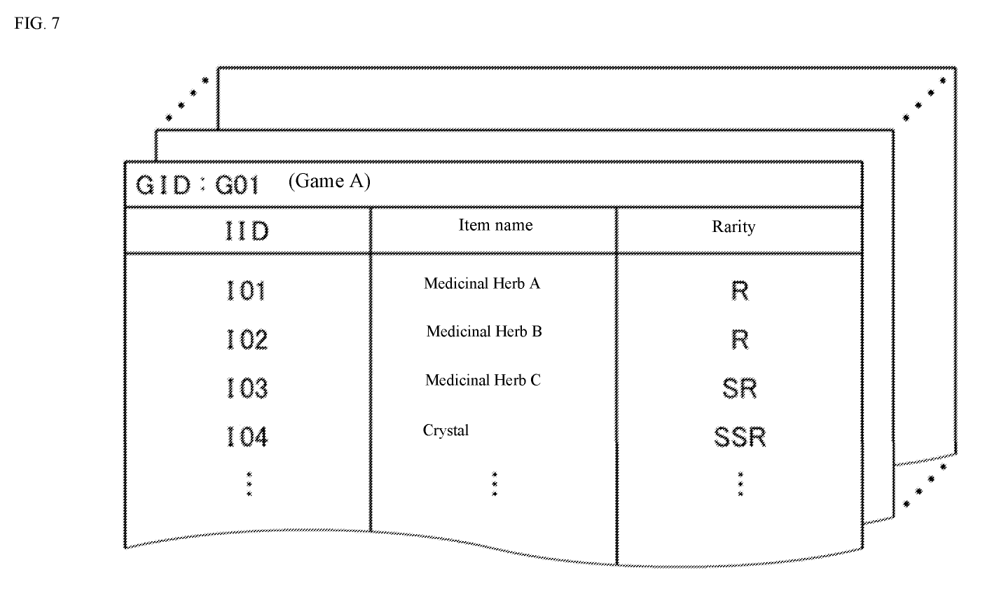

FIG. 7 is a data structure diagram of item information 240 according to one or more embodiments.

The item information 240 is stored in the data storage component 112 of the game server 102. The item information 240 defines the rarity of the items that appear in the game. The item information 240 shown in FIG. 7 is a list of items that appear in the game (G01) (game title “game A”).

The items are each identified by an item ID (hereinafter referred to as the “IID”). Rarity is set for an item. A player can acquire items by a lottery executed in the game (G01). Also, items appear at a predetermined probability when an enemy character is defeated. Rarity is the result of indexing how unlikely it is that an item will appear, and is ranked as SSR, SR, and R in ascending order of appearance probability. In general, an item with a high rarity of SSR is usually more expensive and more useful than items with rarity of SR or R, which are lower rarities.

For example, an item (103) (medicinal herb C: rarity SR) is more effective (such as its hit point recovery effect or its detoxification effect) than an item (101) (medicinal herb A: rarity R), and its price when sold in the game is also higher.

The recruitment of players in the indirect invitation method will now be described, followed by the direct invitation method.

Indirect Invitation Method

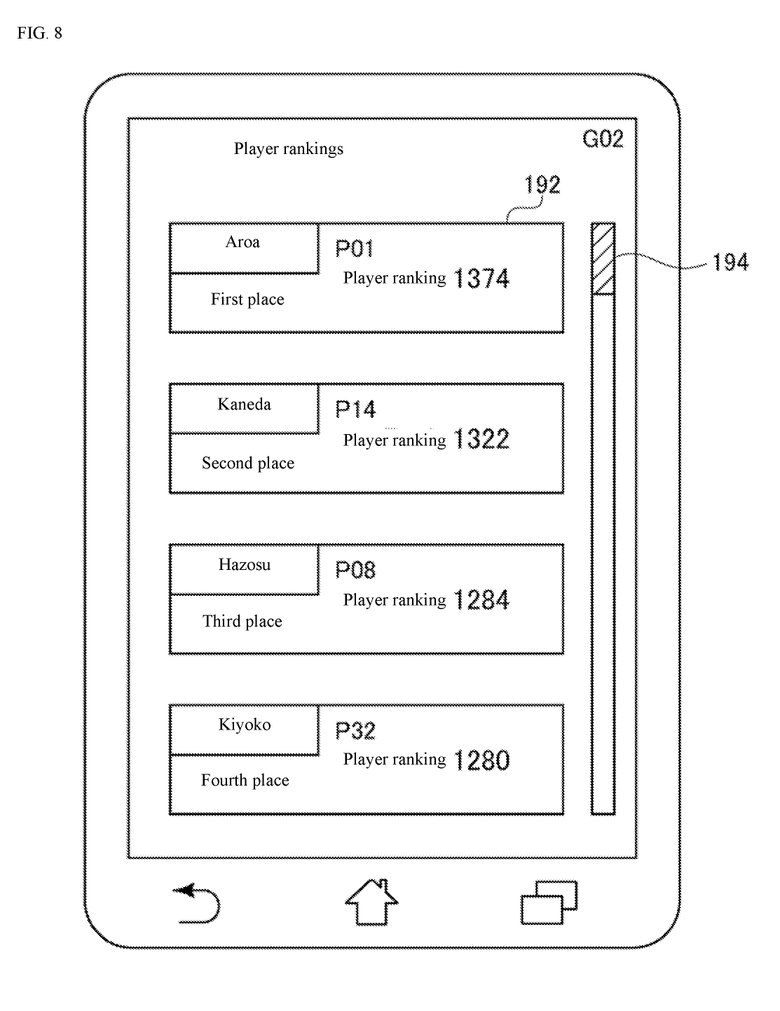

FIG. 8 is a screen shot of a ranking screen 190 according to one or more embodiments.

The ranking screen 190 shown in FIG. 8 is a screen showing the standings of player rankings in the game (G02). Let us assume that the ranking screen 190 in FIG. 8 is displayed on the game terminal 104 of the player (P02). The player (P02) can display the ranking screen 190 at any time during the play of the game (G02). The ranking screen 190 displays a list of a plurality of player information areas 192 in the order of their player ranking. In FIG. 8, the first-place player “Aroa” (player (P01)) through the fourth-place player “Kiyoko” (player (P32)) are shown, but players in fifth place and lower can be checked by operating a scroll bar 194.

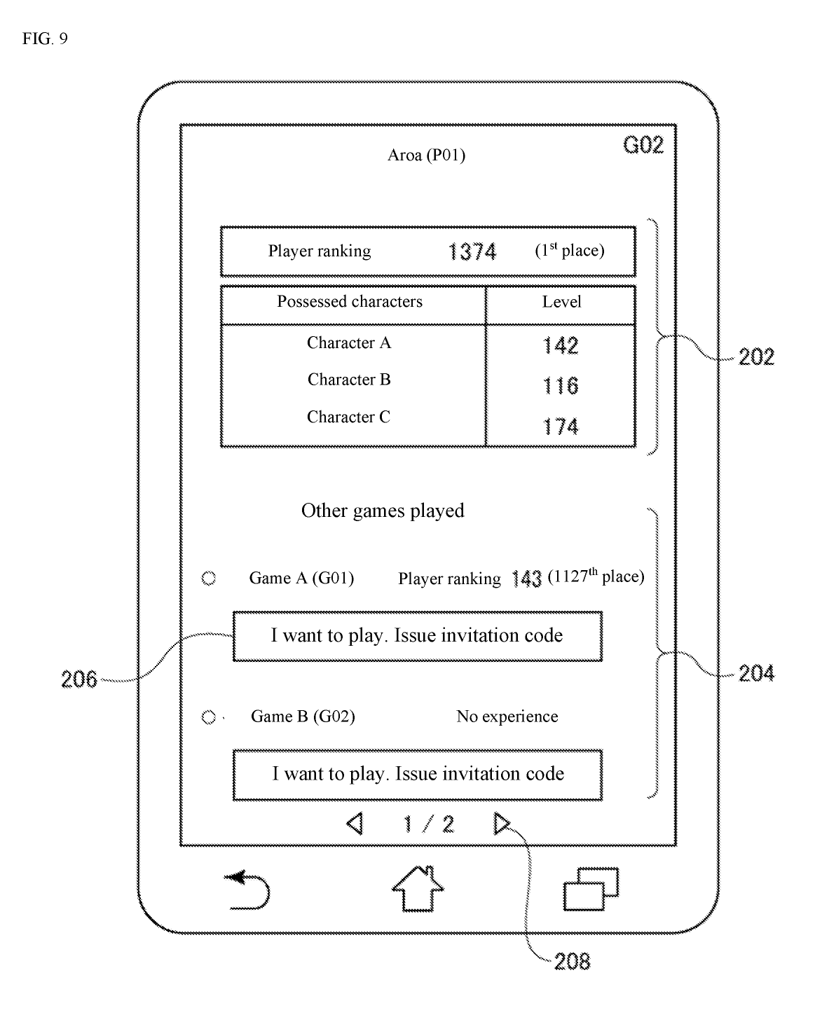

In the player information areas 192 are displayed the player name, player ranking, and overall standing. For example, the player ranking of the first-place player (P01) (player name “Aroa”) is “1374.” The player (P02) can display the profile screen (described below in conjunction with FIG. 9) by touching the player information area 192.

FIG. 9 is a screen shot of a profile screen 200 according to one or more embodiments.

The profile screen 200 shown in FIG. 9 is displayed when the player (P02) touches the player information area 192 of the first-place player (P01) (player name “Aroa”) on the ranking screen 190 in FIG. 8. This profile screen 200 shows the profile of the player (P01).

The profile screen 200 includes a play status area 202 and an invitation game area 204. The play status area 202 shows the play status of the player (P01) in the game (G02). The play status area 202 displays the player ranking of the player (P01) in the game (G02) and his overall standing, as well as the characters the player possesses and his level (proficiency).

The invitation game area 204 shows the invitation games chosen by the player (P01). The player (P01) has chosen the game (G01) (game title “game A”) and game (G03) (game title “game B”) as invitation games. The invitation game area 204 can be switched between a plurality of displays by touching a switch button 208.

The play history in the invitation game of the player (P01) is also displayed in the invitation game area 204. The invitation game region 204 includes an issue button 206. The player (P02) (visitor) can touch the issue button 206 to have an invitation code for the invitation game issued (discussed below). The issue button 206 is an interface that corresponds to the indirect invitation method.

In FIG. 9, the player (P01) (player name “Aroa”: inviting party) has play experience with the invitation game (G01) (game title “game A”), his player ranking is 143, and he is in 1127^{th} place overall. This information is based on the play history information 170 shown in FIG. 3. When a request to register the invitation code for invitation game (G01) is received from the player (P01) (inviting party) during play of the game (G02), the code registration component 124 registers the issue button 206 for the game (G01) on the profile screen 200 of the player (P01), and also refers to the play history information 170 and appends play history to the invitation game area 204.

The player (P01) (inviting party) has no play experience with the invitation game (G03) (game title “Game B”). Therefore, he is displayed as “inexperienced” for the invitation game (G03).

The issue button 206 is set for each invitation game. The player (P02) (invitee) can acquire an invitation code for the invitation game from the profile screen 200 of the player (P01).

Since the play history of the player (P01) for each invitation game is displayed, the player (P02), who is a visitor, can determine how enthusiastic the player (P01) (inviting party) is about the invitation game, or whether he is inexperienced. As mentioned above, the player (P01) has no play experience with the invitation game (G03) (game title “Game B”). Therefore, if the player (P02) enters the invitation game (G03), and the player (P01) also enters the invitation game (G03) in response to this, they can form a lower level group of two people.

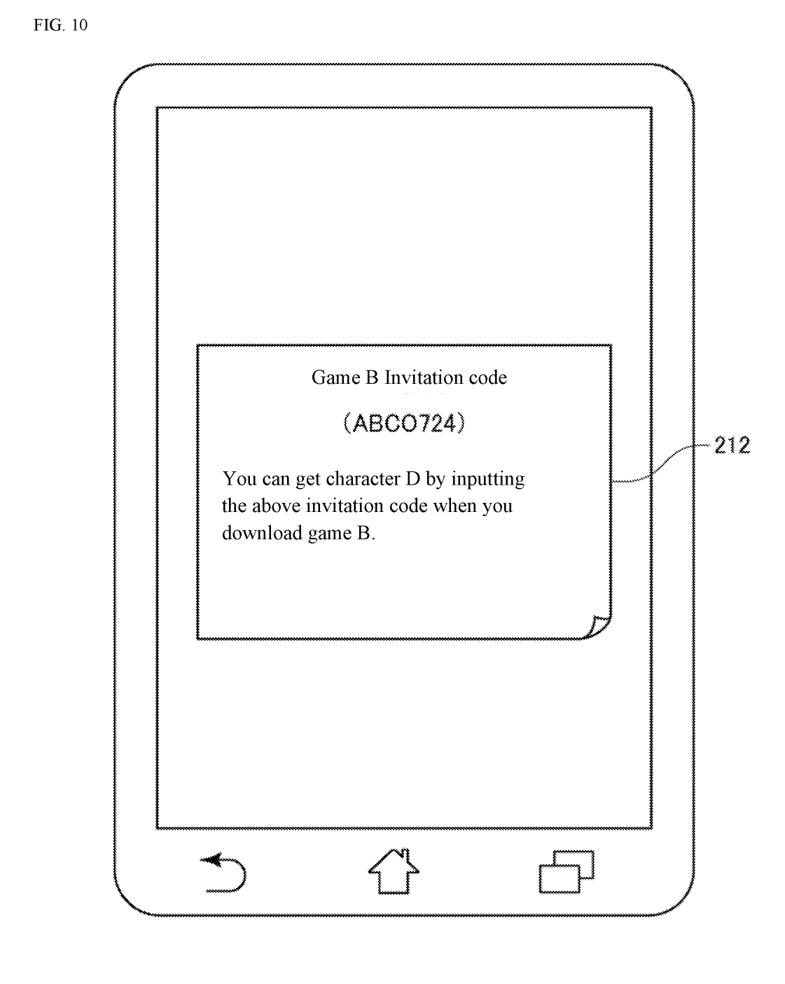

FIG. 10 is a screen shot of an invitation code acquisition screen 210 according to one or more embodiments.

The invitation code acquisition screen 210 shown in FIG. 10 is displayed when the player (P02) touches the issue button 206 for the invitation game (G03) (game title “game B”) on the profile screen 200 in FIG. 9. When the issue button 206 is touched, the code transmitter 140 of the game server 102 transmits an invitation 212 to the game terminal 104 (invitee terminal) of the player (P02). When the player (P02) downloads the invitation game (G03) and registers as a player, and the invitation code indicated in the invitation 212 (the code “ABC0724” in the drawing) is inputted, the reward granting component 120 grants character D as a reward to player (P02). The character D is a character that helps the player in the invitation game (G03). The reward granting component 120 may also grant a reward to the player (P01) (the inviting party).

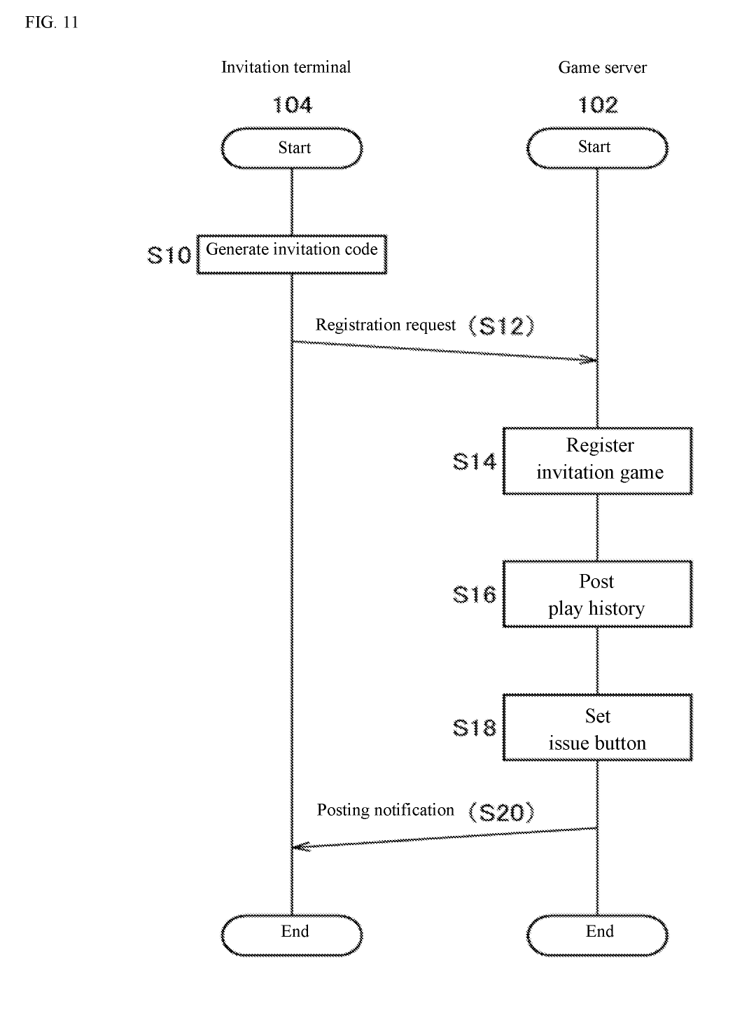

FIG. 11 is a flowchart of the process of posting an invitation game in the indirect invitation method according to one or more embodiments.

The player who is the inviting party first selects the invitation game. After this selection, the game execution component 132 generates an invitation code (character string) for the invitation game (S10). The code registration transmitter 156 transmits a registration request including the game ID of the invitation game, the player ID, and the invitation code to the game server 102 (S12). The code registration receiver 134 of the game server 102 receives this registration request.

The code registration component 124 registers the invitation game specified on the profile screen 200 of the inviting party (S14). The code registration component 124 refers to the play history information 170, detects the play history of the inviting party with the invitation game, and posts this on the profile screen 200 (S16). If the player has no experience with the game (G03), he is displayed as “inexperienced” as shown in FIG. 9. Finally, the code registration component 124 sets the issue button 206 for the invitation game (S18). The code registration component 124 associates the issue button 206 with the invitation code upon the registration request in S12. The code registration component 124 notifies the game terminal 104 of the completion of posting of the invitation code and the invitation game (S20).

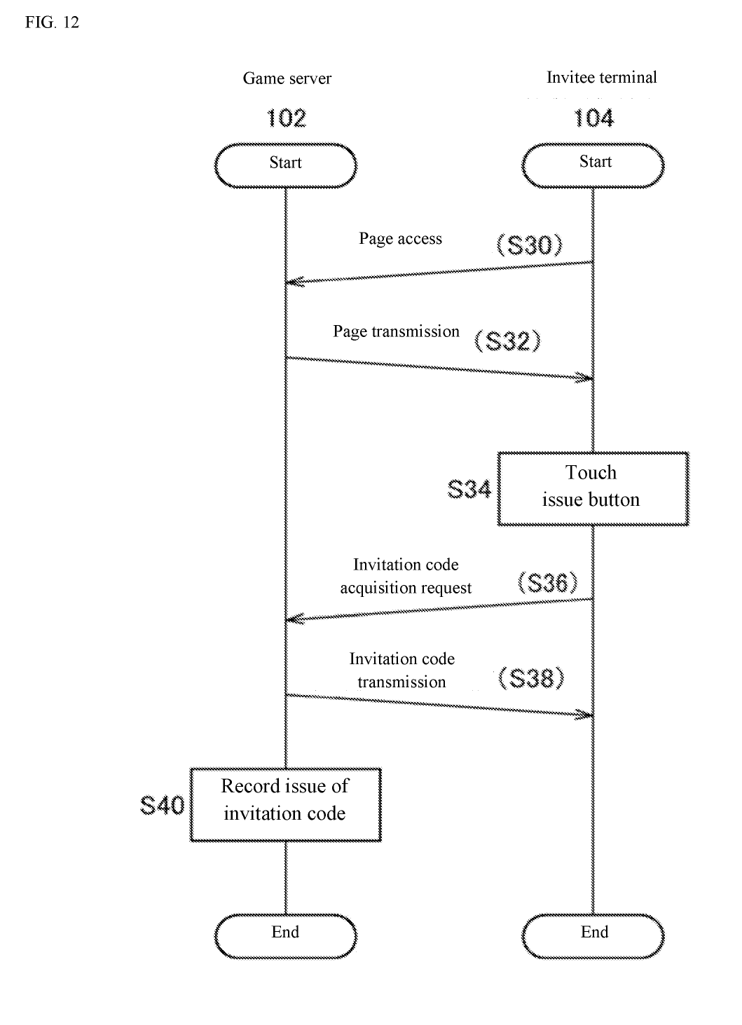

FIG. 12 is a flowchart of the process of issuing an invitation code in the indirect invitation method according to one or more embodiments.

When a player accesses the profile screen 200 of another player, the page access receiver 130 receives an access request from the game terminal 104 (S30). The page transmitter 136 transmits the specified web page (profile screen 200) to the requesting game terminal 104 (invitee terminal) (S32). The communication component 146 of the game terminal 104 (invitee terminal) causes the profile screen 200 to be displayed. The invitee touches the issue button 206 on the profile screen 200 (S34). At this point, the code request transmitter 158 sends the game server 102 a request to acquire an invitation code including the player ID and the game ID, and the code request receiver 138 receives this (S36). The code transmitter 140 sends the game terminal 104 (invitee terminal) the invitation code associated with the issue button, and the code receiver 160 receives this (S38). The code manager 122 records the issue history of the invitation code (S40). For example, the code manager 122 records who acquired an invitation code from which inviting party for which game.

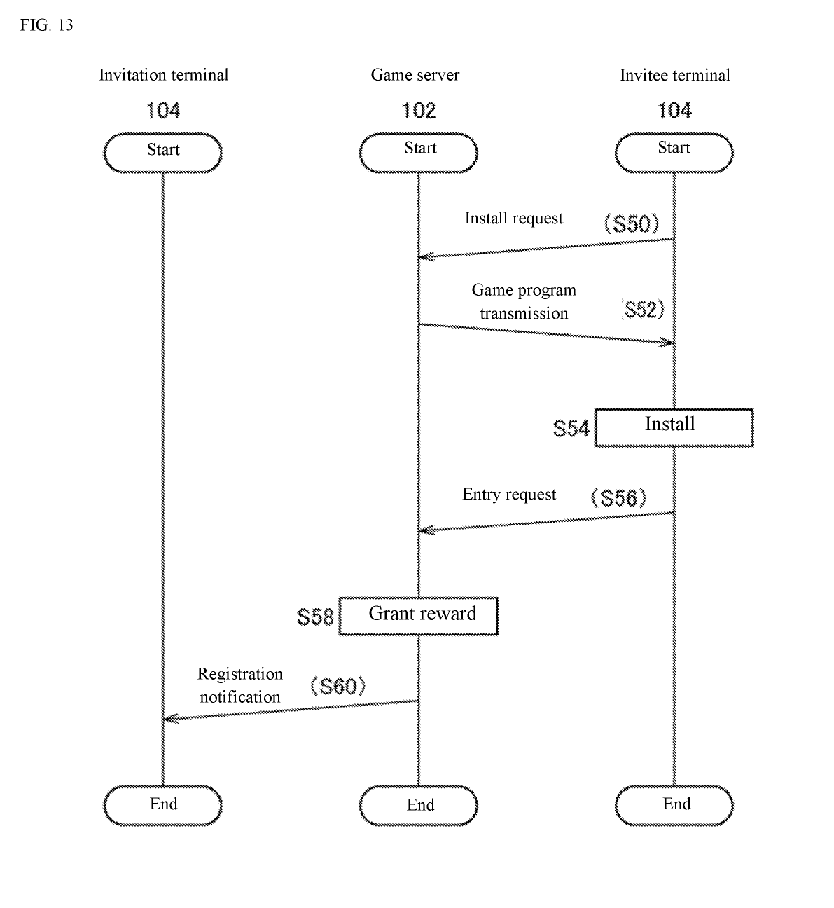

FIG. 13 is a flowchart of the process of downloading a game program according to one or more embodiments.

Here, we will describe a case in which the player (P02) of the invitee terminal downloads the invitation game (G03) of the player (P01) (the inviting party). The invitee terminal first sends a request to install the invitation game (G03) (S50). The game controller 114 sends the game terminal 104 the game program for the game (G03) (S52). The game terminal 104 installs this game program (S54).

After installation, the player registration transmitter 152 automatically sends the game server 102 an entry request including the player ID and the game ID (S56). At this point, if the player (P02) (invitee) inputs the invitation code acquired on the invitation code acquisition screen 210, the invitation code is also transmitted to the game server 102 along with the entry request. Invitation codes that have already been acquired may also be sent automatically while requesting entry.

The reward granting component 120 grants a predetermined reward that can be used in the invitation game (G03) to the player (P02) (invitee) (S58). The character D is granted as a reward to the player (P02) (invitee) as described in connection with FIG. 10. Meanwhile, the reward granting component 120 may also grant a reward to the player (P01) who issued the invitation code. What the rewards are and to whom they are granted are determined based on the granting conditions of the game (G03). A reward that can be used in the game (G03) or a reward that can be used in the game (G01) may be granted to the player (P01). The player (P01) may be able to select whether to receive a reward for the game (G01) or for the game (G03).

Once the player (P02) (invitee) enters, the registration notification component 142 transmits a registration notification to the player (P01) (inviting party) (S60). The notification receiver 162 of the invitation terminal receives this registration notification. The registration notification notifies the player (P01) of the entry into the game (G03) by the player (P02). Because the player (P01) is not registered in the game (G03), a lower level group can be formed by lower level players by inviting the player (P02) upon entry to the game (G03). In this way, the unregistered player (P01) can participate in the game (G03) after arranging a situation in which a lower level group can be formed by recruiting the other unregistered player (P02). Also, the unregistered player (P02) can enter with the expectation of forming a lower level group with the unregistered player (P01) by acquiring the invitation code of the unregistered player (P01).

When an existing player recruits an unregistered player, the existing player can expand the power of his game group by promptly recruiting new players to a game group in which he participates or over which he presides when a registration notification has been received.

The reward granting component 120 grants more rewards to players who have successfully recruited more players. Every time a new player enters with the invitation code of the player (P01), the reward granting component 120 grants an additional reward to the player (P01) (inviting party). The reward granting component 120 may also grant additional rewards to the inviting party when a simultaneous participation relationship has been established among a number of players who have been recruited, or when a matching relationship is established. With this mode, since players that receive attention from many other players and players who have good communication skills and are influential can acquire more rewards, they can advance in the game advantageously. In other words, it is believed that existing players will actively contribute to the expansion of the player pool in order to advance in the game advantageously.

Direct Invitation Method

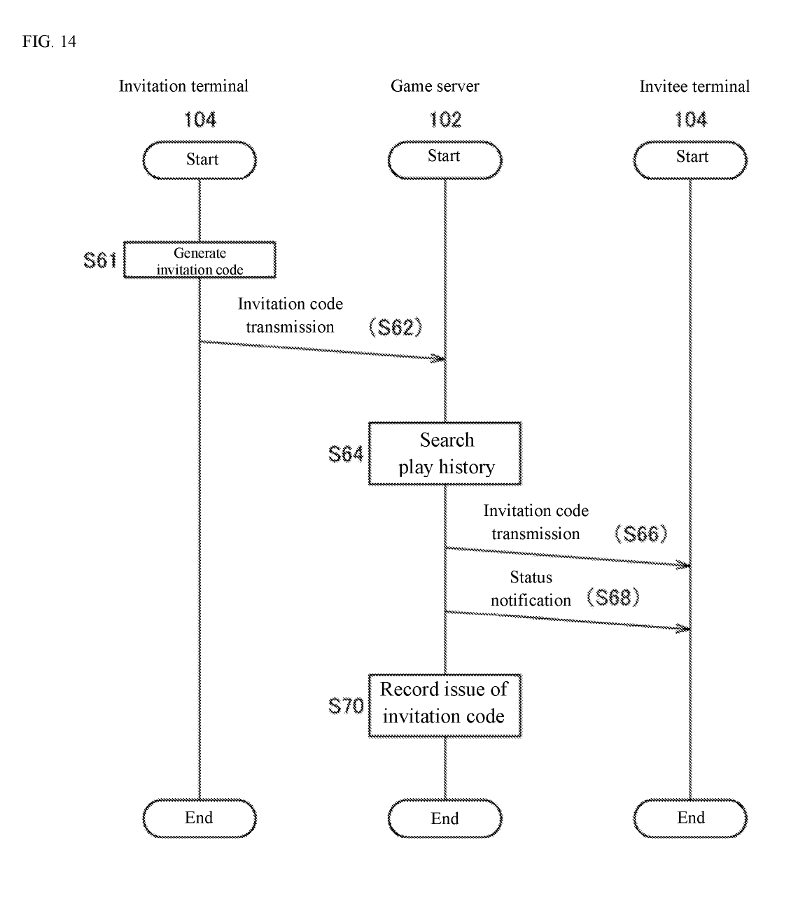

FIG. 14 is a flowchart of the process of transmitting an invitation code in the direct invitation method according to one or more embodiments.

In the direct invitation method, the player who is the inviting party first selects the invitation game. After this selection, the game execution component 132 generates an invitation code (character string) for the invitation game (S61). The code issue transmitter 176 specifies the game ID of the invitation game, the player ID of the inviting party, and the player ID of the invitee, and transmits a request to issue an invitation code to the game server 102 (S62). The code issue receiver 172 of the game server 102 receives this invitation code.

The game controller 114 refers to the play history information 170 and searches for the play history of the inviting party in the invitation game (S64). The code transmitter 140 transmits the invitation code to the invitee terminal (S66). Also, the status notification component 174 notifies the invitee terminal of the play status of the inviting party based on the play history search result (S68). The play status referred to here may be any information indicating the play history of the inviting party in the invitation game, such as whether or not the player has play experience with the invitation game, his total playing time, his player rank, and characters he possesses. The code manager 122 records the issue history of the invitation code (S70).

In the direct invitation method, the inviting party specifies the address of the invitee and sends the invitee terminal the invitation code via the game server 102. The invitee terminal is also notified of the play status of the inviting party. For example, it is believed that the invitee will be more prone to responding to the solicitation of the inviting party if the inviting party is an unregistered player of the invitation game. This is because a lower level group can be formed with the inviting party upon entry to the invitation game.

The processing steps when an invitee downloads the game program for the invitation game is the same as what was described in relation to FIG. 13. When an invitee enters the invitation game, the registration notification component 142 of the game server 102 notifies the inviting party to that effect (S60 in FIG. 13). The inviting party can form a lower level group with the invitee if he himself enters the invitation game after this registration notification.

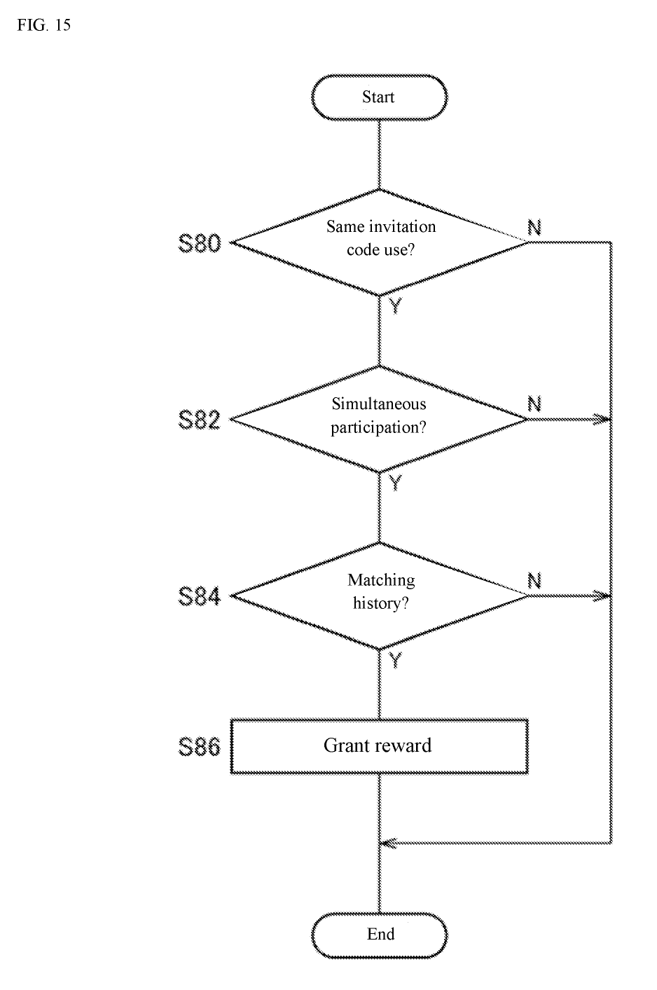

FIG. 15 is a flowchart of the process of granting a reward when an invitee has entered the invitation game based on the invitation code.

The description here is premised on a situation in which another player Y6 enters the invitation game by using the invitation code posted on the profile screen 200 by an existing player X6.

The player registration component 116 of the game server 102 determines whether or not there is another player who has used the invitation code issued by the player X6 to enter the game when the player Y6 has entered the invitation game (S80). When there is such a player Y7 (Yes in S80), the reward granting component 120 determines whether the time difference between the entry of the player Y6 and the entry of the player Y7 is within a quasi-simultaneous time, or in other words, whether or not the player Y6 and the player Y7 are in a simultaneous participation relationship (S82).

If the player Y6 and the player Y7 are in a simultaneous participation relationship (Yes in S82), the matching processor 118 refers to the matching history information 180 and determines whether or not there is any of the matching histories R0 to R2 between the player Y6 and the player Y7 (S84). If there is a matching history (Yes in S84), the reward granting component 120 grants a reward to both of the players Y6 and Y7 (S86). The reward granting component 120 may also grant a reward to the player X6 who is the inviting party for both of these players. On the other hand, the reward granting component 120 does not grant a reward if there has been no entry based on the same invitation code (No in S80), or if no simultaneous participation relationship has been established (No in S82), or if there is no matching history (No in S84).

When a simultaneous participation relationship is established, the registration notification component 142 notifies the game terminal 104 (second game terminal) of the player Y6 (second player) of the entry of the player Y7 (third player), and notifies the game terminal 104 (third game terminal) of the player Y7 of the entry of the player Y6. Notifying players who are in a simultaneous participation relationship of one another's entry encourages the formation of a game group by these players. For example, upon receiving an entry notification the player Y6 can recognize that he can form a lower level group with the player Y7. This control method encourages the formation of a lower level group by new players who enter at the same time.

In addition to the establishment of a simultaneous participation relationship, this notification of entry may be given to the players on the condition that there is a matching history. It is believed that a player is more likely to invite someone who has belonged, even if just once, to the same game group for another game, or with whom he has battled, rather than creating a game group by inviting strangers. This control method encourages the formation or reformation of a game group composed of a plurality of players in a matching relationship, or a plurality of players who used to be in a matching relationship. A game group may also be formed as a lower level group in another game G2 if the members of a game group formed for the game G1 collectively enter this game G2. This control method allows a temporary personal relationship, namely, a matching relationship established in the game G1, to be maintained in another game G2 as well, and this further strengthens exchanges between players.

The following six types are possible for the method of forming a lower level group upon player registration according to one or more embodiments, that is, situations in which a plurality of players enter a game at the same time.

W1: A new player is recruited by an unregistered player by the indirect invitation method.

W2: A plurality of new players are recruited by an unregistered player by the indirect invitation method.

W3: A plurality of new players are recruited by an existing player by the indirect invitation method.

W4: A new player is recruited by an unregistered player by the direct invitation method.

W5: A plurality of new players are recruited by an unregistered player by the direct invitation method.

W6: A plurality of new players are recruited by an existing player by the direct invitation method.

FIG. 15 corresponds to W3 and W6 above. At this point, a plurality of new players invited by an existing player can form a lower level group. The registration notification component 142 of the game server 102 notifies the new players in a simultaneous participation relationship of each other's entry, which encourages them to form a game group of the plurality of new players. Also, the reward granting component 120 may grant a reward to either the inviting party or the plurality of the invitees and thereby encourage the formation of a lower level group in a W3 or W6 situation.

When an unregistered player recruits new players (W1, W2, W4, and W5), a lower level group that includes not only the invitees but also the inviting party can be formed. At this point, the registration notification component 142 notifies not only the other invitees, but also the inviting party of the entry of an invitee. The reward granting component 120 may grant rewards to any of the inviting party and the plurality of the invitees to encourage the formation of a lower level group in the situations W1, W2, W4, and W5.

The reward granting component 120 may grant rewards to players when a plurality of players have entered based on the same invitation code, even though they are not in a simultaneous participation relationship. Here again, the registration notification component 142 may notify the plurality of the players of the entry of the others. The same applies if the plurality of the players entered when at least one of the following conditions is satisfied: the same invitation code, simultaneous participation relationship, and/or matching history.

The game system 100 was described above based on one or more embodiments.

According to one or more embodiments, even an unregistered player with no experience with an invitation game that is available for download can recruit new players by using an invitation code. Since a plurality of new players, including the inviting party, can enter the invitation game at the same time, it is easy to form a lower level group. Even players who might hesitate to enter alone or by the invitation of an upper level player can participate in the game along with other inexperienced players, so there is less reluctance to enter. The same applies when an existing player recruits a plurality of new players.

When an invitee enters the invitation game, the game server 102 notifies the inviting party of the entry of a new player (invitee) (see FIG. 13). If the inviting party is also inexperienced at the invitation game, he can form a lower level group by inviting newly entered invitees. For example, let us assume that a player X8 who is unregistered in the invitation game successfully recruits a player Y8 by the indirect invitation method, and a lower level group of the players X8 and Y8 is formed. Here, let us also assume that yet another player Y9 has entered based on the invitation code of the player X8. The players X8 and Y8 are notified of the entry of player Y9 by the registration notification component 142. The players X8 and Y8 can increase the members of the lower level group to three people by inviting the newly entered player Y9. In this way, the entry of new players by using an invitation code is encouraged, and it is easier to create a large lower level group from the outset of the game by inviting these new players as soon as an entry notification is received.

In the indirect invitation method, an invitee takes the initiative to acquire the invitation code on the profile screen 200 of the inviting party. A player may himself request an invitation code for the game to which he wants to be invited. Those seeking invitation must go through a two-stage confirmation of intent, in which they access the profile screen 200 of another player, and then touch the issue button 206. The over-issuing of invitation codes is a concern with a conventional direct invitation method. An advantage to the indirect invitation method is that it does not involve this “scatter-shot” approach.

Also, a player Y10 who wants to be invited may ask another player X10 to issue an invitation code. This means that the player X10 has to take time to generate an invitation code for the player Y10 and send the code to the player Y10.

In the indirect invitation method, the player X10 may just post the invitation code ahead of time on his own profile screen 200, and then mention to the player Y10 that the invitation code can be acquired by accessing his profile screen 200. Specifically, rather than newly issuing an invitation code in response to a request when an invitation is requested, a player can just tell someone who wants an invitation about this by making the invitation code available ahead of time. This has the advantage of lessening the burden on the inviting party.

The invitation code can be acquired from a web page associated with the inviting party, such as his profile screen 200. If the invitation code is freely posted to a public web page, such as an Internet bulletin board, the web page will end up becoming cluttered. According to one or more embodiments, since the invitation code is posted on the profile screen 200, which is a dedicated web page of the inviting party, it will not bother the general public visiting the page.

According to one or more embodiments, the more successful the inviting party is at recruitment, the more additional rewards he will be granted, so this motivates the player to recruit. Also, a reward is granted to the inviting party when an invitee plays the invitation game steadily enough to meet a continuation condition. Accordingly, it is anticipated that the inviting party will take altruistic or reciprocal action toward an invitee in order to urge the invitee to continue playing. For example, it is believed that the inviting party will provide items, etc., to invitees belonging to the same game group, and actively make contact via the SNS. Setting a continuation condition for granting a reward is expected to have the effect of not only expanding the new player pool, but also getting new players hooked on the invitation game. Also, it is believed that a player who has a solid reputation for generous support for invitees will find it even easier to recruit new players. Granting rewards in response to successful recruitment and meeting a continuation condition encourages the formation, maintenance, and active use of lower level groups, as well as altruistic and reciprocal action on the part of the players.

The present invention is not limited to or by the above embodiments and modification examples, and can be embodied by modifying the constituent elements without departing from the gist. Various inventions may be formed by appropriately combining a plurality of the constituent elements disclosed in the above embodiments and modification examples. It is also possible to omit some of the constituent elements shown in the above embodiments and modification examples.

The game system 100 was described as being constituted by a plurality of game terminals 104 and one game server 102, but some of the functions of the game terminal 104 may be realized by the game server 102, and some of the functions of the game server 102 may be allocated to the game terminals 104. Also, a third device other than the game terminals 104 and the game server 102 may handle some of the functions.

The game system 100, which is a collection of the functions of the game terminals 104 and the game server 102 as illustrated in FIG. 2, can also be thought of broadly as a single “information processing device.” How the functions required to work according to one or more embodiments of the present invention are distributed to one or more pieces of hardware may be decided in consideration of the specifications required of the game system 100 and the processing performance of each piece of hardware.

### Modification Example

When the inviting party issues an invitation code for an invitation game with which he has no experience, the game controller 114 may impose a restriction on the play of the inviting party until an invitee uses this invitation code to enter the game, or in other words, until he succeeds at recruiting an invitee. For example, there may be a time lag from when a player X11 with no experience in the invitation game G1 registers an invitation code on his profile screen 200 until another player uses this invitation code to enter the game. After posting the invitation code, player X11 may enter the invitation game G1 without waiting for successful recruitment and may have become familiar with the invitation game G1 by the time he successfully recruits. In view of this, the fact that the player X11 (inviting party) is inexperienced (unregistered) in the invitation game can be defined as a “restriction condition,” and when the player X11 who meets the restriction condition has registered the invitation code on the profile screen 200, or when the player X11 has sent the invitation code to another player by the direct invitation method, the game controller 114 may prohibit the entry of the player X11 into the invitation game G1 until he succeeds at recruiting. With this control method, when an invitee enters, the inviting party is also still inexperienced, and this makes it easier for a lower level group to be formed.

The restriction condition may be defined based on the play history of the inviting party, and may at least be a condition that defines how much progress the inviting party has made in playing the invitation game, such as his proficiency and possessions. For example, a restriction condition may be set that indicates that player is a beginner, such as that the total play time of the inviting party in the invitation game is within a specified length of time, or that a certain mission in the invitation game has not been completed. Alternatively, a restriction condition may be set that indicates that the player is advanced, such as that he possesses an item (I12), or that his total play time is equal to or greater than a specified length of time.

Also, play restriction by the game controller 114 may be set to limit or impede the inviting party from advancing in the invitation game G1, such as prohibiting entry into the invitation game G1, limiting the total play time, limiting the play time per day, limiting which items can be possessed, and preventing advancement in player rank.

The game controller 114 may remove the above play restrictions in response to the entry of an invitee, may remove them when a certain action is performed by an invitee in the invitation game, such as when the invitee has played for at least one hour in total, or may remove them when a specified length of time has passed since the invitation code was issued or registered.

The reward granting component 120 may grant a reward that is more valuable to the inviting party when an unregistered player has succeeded at recruiting another player, than when an existing player has succeeded at recruiting another player. Encouraging recruitment by unregistered players over recruitment by existing players further encourages the formation of lower level groups originating from unregistered players. Also, when the above restriction conditions are set, play ends up being restricted until an unregistered player succeeds at recruiting another player. In return, a reward that is more valuable can be granted when an unregistered player has succeeded at recruiting another player, which helps to strike a good game balance.

The reward granting component 120 also grants a reward to the inviting party when the continuation condition is met. In one or more embodiments, it was described that the continuation condition is met when an invitee has logged in to the invitation game five times in a row. In addition to this, various continuation conditions can be set based on how much the invitee has progressed and invested in the invitation game, such as the total play time of the invitation game by the invitee exceeding a predetermined length of time, or the player rank being at or above a certain level.

Each time a continuation condition is met, the reward granting component 120 may grant a new reward to the inviting party or the invitees. Rewards that have already been granted may also be changed. For example, let us assume that the reward granting component 120 has granted the inviting party a “sword” as a reward for successful recruitment when the inviting party has succeeded at recruiting an invitee. After this, when the invitee has met a continuation condition, the reward granting component 120 may increase the attack power parameters set for this sword, or may change it to a more powerful sword (such as a “broadsword”). With this control method, the more an invitee invests in the invitation game, the more advantageously the inviting party can advance in the game. Even if the inviting party himself encounters setbacks in the invitation game and stops playing it, he might still be granted many rewards when the invitees meet various continuation conditions. Even though the inviting party has stopped playing the invitation game, the game keeps advancing advantageously for him through the invitation game, so he is encouraged to play the invitation game once again.

Similarly, the reward granting component 120 may grant additional rewards to the inviting party in proportion to how successful the inviting party is at recruiting many players, or rewards that have already been granted may be changed.

In one or more embodiments, it was described that in recruitment by the direct invitation method, the invitee terminal is notified of the play status of the inviting party (S68 in FIG. 14). The play status at this point is not limited to whether or not the player is unregistered, and other notifications regarding the play status may also be sent, such as the most recent date and time of play, possessed items, and how many times the player has responded to requests from other players in the game group (for example, item swapping or lending). Sending notifications of the play status of the inviting party at the time of recruitment makes it easier for the invitee to determine whether or not to accept the invitation of the inviting party.

An invitee may set filter conditions for the play status of the inviting party in advance. For instance, possible filters might include receiving an invitation code only from an unregistered party, receiving an invitation code only for a certain game (G01), receiving an invitation code only from a female player, and receiving an invitation code only from a player living in Tokyo. The invitee 160 may refuse to receive an invitation code that does not match the filter conditions.

“Simultaneous participation” in one or more embodiments means that the time difference between the entry of the player Z6 and the entry of player Z5 is within the quasi-simultaneous period (24 hours). In a modification example, an expiration date may be set for the invitation code. For example, a plurality of players who enter the invitation game using an invitation code having an expiration set for 24 hours after the registration to the profile screen 200 may be regarded as “simultaneous participation.”

Rather than using an invitation code, a plurality of players may decide on a password and form a lower level group at the same time as they enter. For instance, let us assume that three players Z7 to Z9 decide on a password W, either orally or via an SNS. The players Z7 to Z9 also input the password W when they enter the game G1. When the passwords W of the three players match, the matching processor 118 forms a game group (lower level group) that includes the three players. The reward granting component 120 may grant a reward to the players when a plurality of players thus enter the same game by using the same password W. This control method encourages the formation of a lower level group without having to use an invitation code.

In one or more embodiments, it was described that a reward is given to the inviting party when a continuation condition such as the continuous login of an invitee is met. In a modification example, when a player X12 has succeeded at recruiting a player Y12, and the player Y12 has succeeded at recruiting a player Y13, the reward granting component 120 may grant a reward not only to the players Y12 and Y13, but also to the player X12 who was the indirect cause of the player Y13 being recruited to the invitation game.

In one or more embodiments, the entry of an invitee is recognized when the inviting party receives a registration notification (S60 in FIG. 13). Therefore, if the inviting party is an unregistered player, the inviting party can recognize the possibility of forming a lower level group upon receiving a registration notification. As a modification example, a game group may be automatically generated upon registration notification. For example, if an unregistered player X14 enters after having succeeded at recruiting a player Y14, the matching processor 118 may automatically generate a game group including the player X14 and the player Y14, or the player Y14 may be set as a friend of the player X14. Alternatively, the registration notification component 142 may transmit a registration notification and cause the game terminals 104 to display a scene prompting the players X14 and Y14 to determine whether to form a game group or to make a friend setting.

The reward granting component 120 may grant a reward to a plurality of newly registered players on the condition that these players have formed a game group or have become friends. The reward granting component 120 may also grant a reward to an existing player on the condition that a plurality of players established a matching relationship when these players entered the invitation game at the invitation of an existing player.

An upper limit may be provided to the number of players that can be recruited with a single invitation code.

In one or more embodiments, it was described that an invitation code is generated at a game terminal 104. As a modification example, an invitation code may be generated at the game server 102. The code registration transmitter 156 of the invitation terminal sends the game server 102 a registration request including the game ID of the invitation game and the player ID. When the code registration receiver 134 of the game server 102 receives the registration request, the code registration component 124 generates an invitation code, and the invitation code is recorded after being associated with the game ID and the player ID. The game server 102 may notify the inviting party with the particulars of the invitation code, or may only notify that the invitation code was generated and not convey the invitation code itself.

In one or more embodiments, it was described that reward granting or registration notification is executed on the condition that an invitee has used an invitation code to enter the invitation game. The “entry” (player registration) referred to here encompasses not only when a player gives an explicit entry indication, but also an implicit entry such as when the game server 102 recognizes a new player and temporarily records player information, such as the IP address of the game terminal 104. Reward granting and registration notification may be set to be executed once a player has downloaded a game program, or has played a game at least one time, or has played a game for at least a predetermined length of time.

In one or more embodiments, it was described that a player installs a game and inputs the invitation code when he enters the game. As a modification example, the invitation code received by the code receiver 160 may be stored in the data storage component 150, and entry and invitation code input may be automatically executed by the communication component 146 of the game terminal 104 and the communication component 108 and data processor 110 of the game server 102 when the game is installed.

In one or more embodiments, three types of matching history R0 to R2 are defined in the matching history information 180. In addition to this, there can be many different kinds of relationships between players, such as living in the same town, being within three years of the same age, having the same hobbies registered in their profiles, and playing the same game. The matching processor 118 may refer to an address book registered in the game terminal 104 to specify players who are in a relationship in which they know each other's contact information. The registration notification component 142 may also execute registration notification when there is matching history other than the above-mentioned R0 to R2. For example, the registration notification component 142 may transmit a registration notification to a player X15 only when a player who is registered in the address book of player X15 has entered the invitation game of player X15.

In one or more embodiments, it was described that when the inviting party notifies the game server 102 of the invitation game, the code registration component 124 adds the issue button 206 corresponding to invitation game to the profile screen 200. As a modification example, the code registration component 124 may append the invitation code itself to the profile screen 200. The code registration component 124 may attach the invitation 212 just as it is to the profile screen 200. An interface may be registered in order to issue an invitation code such as the issue button 206, or the invitation 212 including the invitation code may be posted so as to allow acquisition, or the invitation code may be posted in a readable format.

An expiration date may be set for the invitation code. The code registration component 124 may automatically delete the issue button 206 from the profile screen 200 once a predetermined number of days have passed since the addition of the issue button 206 to the profile screen 200. Also, when an invitee has registered as a player after having acquired an invitation code, the reward granting component 120 may grant a reward on the condition that the player registration was executed before the expiration of the invitation code. An upper limit to the number of invitation codes that can be issued within a certain period may be set. These restriction settings allow the value of the invitation code to be raised by keeping the invitation code from being overused.

When the issue button 206 is touched to acquire an invitation code, the code transmitter 140 may transmit a friend request confirmation screen asking the player (invitee) whether or not to make a friend request, along with the invitation code. If the invitee selects the friend request, the matching processor 118 of the game server 102 notifies the invitation terminal that there is a friend request, and if the inviting party accepts, the two are set as friends.

When the invitation code is used to enter the game, the matching processor 118 may automatically set the two people as friends. Similarly, the registration notification component 142 may send the inviting party a friend request confirmation screen asking the inviting party whether or not to make a friend request. When the inviting party selects the friend request, the matching processor 118 notifies the invitee terminal that there is a friend request. If the invitee accepts, the matching processor 118 sets the two as friends.

In one or more embodiments, a game that had already been released was described. The term “already released” here may mean that the game can be downloaded, or that the player data of other players has been registered in the game, that the game program has been uploaded at least to a server used for downloading, that there is a mix of existing players who have issued an invitation code after starting the game and players who begin playing the game after the invitation code was issued, that an invitation code sent from an unregistered player and an invitation code sent from an existing player are both present at the same time, and so forth.

Rewards are not limited to being usable in a game, and may also be useful in real life. For example, movie tickets, discount tickets for game centers and retail stores, event tickets, and the like may be given as a reward.

The invitation code is not limited to the profile screen 200, and can also be acquired on a web page set up in association with the inviting party. For example, an interface for acquiring an invitation code may be registered in the player information area 192 of the ranking screen 190, or an invitation code may be posted on a dedicated page that corresponds to a game group.

In one or more embodiments, a game played on a smartphone was described, but the game system 100 may be realized by a home game machine, a personal computer, or the like. The game may also be an arcade game or may be tied to an arcade game.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.
100 game system,
102 game server,
104 game terminal,
106 Internet,
108 communication component,
110 data processor,
112 data storage component,
114 game controller,
116 player registration component,
118 matching processor,
120 reward granting component,
122 code manager,
124 code registration component,
126 player registration receiver,
128 matching request receiver,
130 page access receiver,
132 game execution component,
134 code registration receiver,
136 page transmitter,
138 code request receiver,
140 code transmitter,
142 registration notification component,
144 user interface processor,
146 communication component,
148 data processor,
150 data storage component,
152 player registration transmitter,
154 matching request transmitter,
156 code registration transmitter,
158 code request transmitter,
160 code receiver,
162 notification receiver,
164 input component,
166 output component,
170 play history information,
172 code issue receiver,
174 status notification component,
176 code issue transmitter,
180 matching history information,
190 ranking screen,
192 player information area,
194 scroll bar,
200 profile screen,
202 play status area,
204 invitation game area,
206 issue button,
208 switch button,
210 invitation code acquisition screen,
212 invitation,
220 granting condition information,
230 login information,
240 item information

What is claimed is:

1. A game server connected to a plurality of game terminals via a communication network, comprising:
a receiver that receives a first request to register an invitation code for a game available for download, from a first game terminal operated by a first player;
a memory;
a processor connected to the memory and that causes the memory to register the invitation code in a state that allows acquisition from another game terminal; and
a transmitter, wherein
the receiver receives a second request to acquire the invitation code from a second game terminal operated by a second player,
the transmitter transmits the invitation code to the second game terminal in response to the reception of the second request, and
the processor causes the memory to register the invitation code based on the reception of the first request, regardless of whether or not the first player has a game play history.

2. The game server according to claim 1, wherein
in response to the game play history by the first player meeting a predetermined restriction condition, the processor sets a restriction on the first player to play the game when the invitation code has been registered in the memory, and
the processor removes the restriction when the second player who acquired the invitation code has registered as a player in the game.

3. The game server according to claim 1, wherein the transmitter transmits a notification that notifies the first game terminal of the player registration of the second player when the second player has registered as a player in the game after the acquisition of the invitation code.

4. The game server according to claim 1, wherein
in response to a player other than the first player being registered as a player in the game after the acquisition of the invitation code provided by the first player, the processor causes the memory to grant the first player a reward, and
the processor causes the memory to vary the reward to be granted to the first player according to the number of players who have registered as players in the game after the acquisition of the invitation code provided by the first player.

5. The game server according to claim 1, wherein
in response to the second player being registered as a player in the game after the acquisition of the invitation code provided by the first player, the processor causes the memory to grant the first player a reward, and
the processor causes the memory to grant another reward to the first player when the game play history by the second player meets a predetermined continuation condition.

6. A game server connected to a plurality of game terminals via a communication network, comprising:
a receiver that receives a request to issue an invitation code for a game specified by a first player, from a first game terminal operated by the first player; and
a transmitter that transmits the invitation code to a second game terminal,
a processor causes the receiver to receive a request to issue the invitation code from the first player regardless of whether or not the first player has a game play history.

7. The game server according to claim 1, wherein the transmitter transmits a notification that notifies the second game terminal of a play status of the game in the first player.

8. A game server connected to a plurality of game terminals via a communication network, comprising:
a receiver that receives a first request to register an invitation code for a game specified by a first player, from a first game terminal operated by the first player;
a memory;
a processor connected to the memory and that causes the memory to register the invitation code in a state that allows acquisition from another game terminal; and
a transmitter, wherein
the receiver receives a second request to acquire the invitation code, from a second game terminal operated by a second player and from a third game terminal operated by a third player;
the transmitter transmits the invitation code to the second game terminal and to the third game terminal; and
the transmitter transmits a notification that notifies the second game terminal of the player registration of the third player, and
in response to the second player being registered as a player in the game after the acquisition of the invitation code of the game and the third player being registered as a player in the game after the acquisition of the invitation code of the game, the terminal transmits a notification that notifies the third game terminal of the player registration of the second player.

9. The game server according to claim 8, wherein the transmitter transmits a notification that notifies the second game terminal and the third game terminal of player registration in the game when there is matching history between the second player and the third player.

10. The game server according to claim 8, in response to the second player being registered as a player in the game after the acquisition of the invitation code of the game and the third player being registered as a player in the game after the acquisition of the invitation code of the game and within a predetermined time period since the player registration of the second player, the processor causes the memory to grant a reward to one or more of the first player, the second player, and the third player.
